(19) United States
(12) Patent Application Publication
(10) Pub. No.: US 2006/0247052 A1
(43) Pub. Date: Nov. 2, 2006

(54) Game information processing apparatus and game control program

(76) Inventors: Yasuhito Baba, Tokyo (JP); Eiji Horita, Tokyo (JP)

Correspondence Address: JORDAN AND HAMBURG LLP, 122 EAST 42ND STREET, SUITE 4000, NEW YORK, NY, 10168, US

(21) Appl. No.: 11/414,595

(22) Filed: Apr. 28, 2006

(30) Foreign Application Priority Data
Apr. 28, 2005 (JP) 2005-130860

(51) Int. Cl. A63F 13/00; A63F 9/24

(52) U.S. Cl. 463/40; 463/42; 463/43

(57) ABSTRACT

The background is a office background consisting of right-half portion of the background and a left-half portion of the background. By loading just one image, both the backgrounds and can be displayed. The event information can be constructed and output by loading (reading) the speakers' images and messages, and by combining the background images with them. Advantages of the invention include that user stress is minimized when loading the information.

### BACKGROUND OF THE INVENTION

The present invention relates to a game information processing apparatus and to a game control program.

When a game is executed by conventional game information processing apparatuses or by conventional game control program which occasionally load programs and information such as data, it takes sometimes long time for the loading. So, the users have to endure long time waiting and even black-out image of the monitor.

For example, the data is frequently loaded during a baseball game is executed, in the case that the data of the stadium and players are loaded before the game starts, or in the case that events are generated during the game. The game is suspended when the events occur and it will be a stressful time for the user.

The present invention is invented so as to solve the above conventional problems and has an object to minimize the user's stress when loading the information and so forth.

### BRIEF SUMMARY OF THE INVENTION

According to the present invention, a game information processing apparatus comprises a display means for displaying an event on a display monitor, the events being generated when a predetermined condition is fulfilled, a memory means for storing events data information for executing the event generated, the events data information comprising first and second data groups, a reading means for selectively reading data corresponding to the event from both the first and second data groups, an event data constructing means for constructing the read data of the first and second groups so as to construct the event data information, a timing determining means for determining a execution timing of the event data information read by the reading means, a plural events judging means for judging, when a plurality of events are generated, whether the events are to be executed at a simultaneous timing or not, a first sorting means for sorting the plurality of events to be executed at the simultaneous timing with respect to the first data, a second sorting means for further sorting the plurality of events sorted by the first sorting means, with respect to the second data, a switching means for switching the event data information in a order corresponding a sorting result of the events sorted by the first and second sorting means, and an event execution means for executing the event data information switched by the switching means.

Therefore, the information loading time is decreased.

A game control program according to the present invention comprises a display step for displaying an event on a display monitor, the events being generated when a predetermined condition is fulfilled, a reading step for selectively reading data corresponding to the event, from a memory means, events data information for executing the event generated, the events data information comprising first and second data groups, an event data constructing step for constructing the read data of the first and second groups so as to construct the event data information, a timing determining means for determining a execution timing of the event data information read by the reading step, a plural events judging step for judging, when a plurality of events are generated, whether the events are to be executed at a simultaneous timing or not, a first sorting step for sorting the plurality of events to be executed at the simultaneous timing with respect to the first data, a second sorting step for further sorting the plurality of events sorted by the first sorting means, with respect to the second data, a switching step for switching the event data information in a order corresponding a sorting result of the events sorted by the first and second sorting means, and an event execution step for executing the event data information switched by the switching means.

Therefore, the information loading time is decreased.

In a game information processing apparatus and a game control program according to the present invention, the data of the first data group may include an image data image data and the data of the second data group may include an explanation text data explaining the event. The image data of the first data group may includes a background image data, and the data of the second data group may include an image of speakers.

In a game information processing apparatus and a game control program according to the present invention, the data of the second data group may include image of speakers.

In a game information processing apparatus and a game control program according to the present invention, the switching means pans one background image when the background image is commonly used for the events executed at the simultaneous timing.

Therefore, image switching time is decreased and the events are

### BRIEF DESCRIPTION OF THE DRAWINGS

Accompanying the specification are figures which assist in illustrating the embodiment of the invention in which:

FIG. 1 is a block diagram showing an example of a game system which includes an embodiment of the game information processing apparatus according to the present invention;

FIG. 2 is a block diagram showing the game information processing apparatus in FIG. 1;

FIG. 3 is figure showing an event image of a baseball game executed by a game information processing apparatus;

FIG. 4 is figure showing another event image of a baseball game executed by a game information processing apparatus;

FIG. 5 shows an image including a continuous backgrounds used in the events of FIGS. 3 and 4;

FIG. 6 is figure showing further another event image of a baseball game executed by a game information processing apparatus;

FIG. 7 is an image showing a series of backgrounds used in the events of FIG. 6 and others;

FIG. 8 is a diagram showing an example of events generation timing;

FIG. 9 is a table showing backgrounds and speakers in respective events in FIG. 8;

FIG. 10 is a flowchart showing a processing for generating events of the game information processing apparatus;

FIG. 11 is a flowchart showing a processing for sorting with respect to plurality of backgrounds;

FIG. 12 is a flowchart showing a processing of sorting with respect to a plurality of speakers; and

FIG. 13 is a flowchart showing a processing for generating a plurality of events.

### DETAILED DESCRIPTION OF THE INVENTION

Next, an embodiment of the game information processing apparatus and game control program according to the present invention are described with reference to the drawings.

### Embodiment

[Game Information Processing Apparatus]

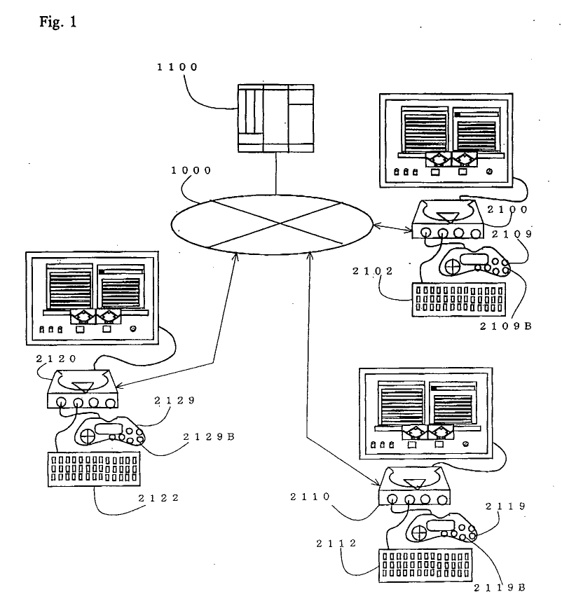

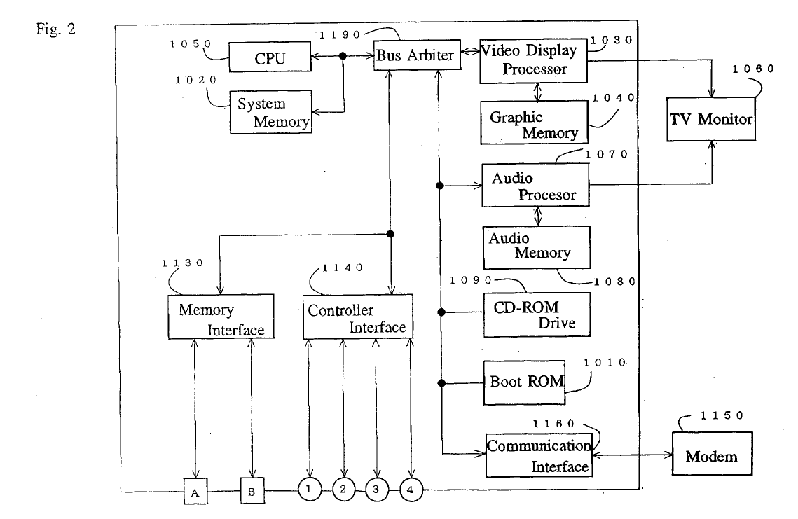

FIG. 1 is a block diagram showing an example of a game system which includes an embodiment of the game information processing apparatus according to the present invention. FIG. 2 is a block diagram showing the game information processing apparatus in FIG. 1.

In FIG. 1, the game system includes a network 1000, a server 1100 connected to the network 1000 and a plurality of game machines (game information processing apparatuses) 2100, 2110 and 2120. Only three game machines are shown in FIG. 1, however more users (game machines), for example several thousands or several ten thousands users may be connected to the network 1000.

The server 1100 controls a game with inputting to and receiving from the game machines 2100, 2110 and 2120 various information. The users (not shown) of the game machines 2100, 2110 and 2120 operate the game machines by means of controllers 2109, 2119 and 2129, so that games controlled by the server 100 is executed on the game machines.

The controller 2109, 2119 and 2129 and key-boards 2102, 2112 and 2122 are connected to the game machines 2100, 2110 and 2120, respectively, and users carry out various operations by means of the controllers 2109, 2119 and 2129 when the games are executed.

There are network games a plurality of users can join in. When the game machines 2100, 2110 and 2120 join a common network game, necessary images for respective users existing in a common virtual space are displayed on display monitor 2105, 2115 and 2125, respectively.

Each of the game machines 2100, 2110 and 2120 has a construction in FIG. 2, for example.

In FIG. 2, the game machine (2100, for example) includes a CPU 1050 which controls the total components of the game machine, a boot ROM 1010 which stores a program for starting the game machine, and a system memory 1020 which stores a program executed by the CPU 1050 and data.

The game machine includes a video display processor 1030 which generates and controls images to be displayed and a graphic memory 1040 which stores generated images. The video display processor 1030 displays an image on a display portion (TV monitor) 1060 according to the generated images.

The game machine includes a audio processor 1070 which generates sound and an audio memory 1080 which stores data of the generated sound. The audio processor 1070 generates digital signals of the sound according to the stored data. The digital signals are transformed into analog signals and amplified into adequate amplitudes so as to be input to the TV monitor 1060 etc. which generates sound.

There are provided card slots A and B in the game machine, which memory cards as memory mediums are inserted into. A memory interface 1130 is connected to the card slots A and B. Data of the users status etc. of games can be stored in the memory cards. After a game is interrupted, the game can be restarted by reading the data from the memory card through the memory interface 1130 into the system memory 1020.

There are provided terminals 1, 2, 3 and 4 which the controller (2109, 2119, 2129) are connected to. A controller interface 1140 is connected to the terminals 1, 2, 3 and 4.

Other than the controller (2109, 2119, 2129), a microphone (not shown) can be connected to the terminals 1, 2, 3 and 4 and the controller interface 1140 so that sound information transformed within the microphone is input to the game machine.

The game machine includes a communication interface 1160 which a modem 1150 is connected for transmitting to and receiving from other game machines game programs and data. Therefore, it is possible to fight against, to cooperate with, to communicate with and to operate other operations with other users in the network game.

The game machine includes a bus arbiter 1170 which arbitrates mutual communication between the CPU 1050 and other components. The program and data are occasionally read from and written into the components by the bus arbiter 1170.

The game program and various data are stored in a optically readable memory medium (memory means) such as CD-ROM (not shown). The game machine includes a CD-ROM drive 1090 which read the CD-ROM.

The memory medium is not limited to CD-ROM. A magnetically readable and writable medium such as a floppy-disk, a optically readable and writable medium such as CD-R and DVD-R and so forth may be applied. The boot ROM can be omitted if the starting program is stored in the memory medium.

The TV monitor 1060 may be a CRT, color LCD, plasma display, DLP type projector and other various display means.

The communication with other game machines may be a serial or parallel communication of wired or wireless type, and various other communication are applicable.

The construction of the game machine is not limited to that of FIG. 2. A general purpose computer and an information processing terminal such as a portable computer and mobile phone may be applied to the game machine and other game processing terminals.

When the game system according to the present invention is constructed by a general purpose computer as the game machine, a program, executable by the computer, is read by the computer. The program includes program codes which let the computer execute respective steps of the program for executing the game.

The program for the general purpose computer to execute the game is read from a ROM incorporated within the computer, from a memory medium readable by the computer or through the network 1000 from a server 1100.

The game is not limited to that executed in the game system. The game may be executed by one game machine independent from other game machines.

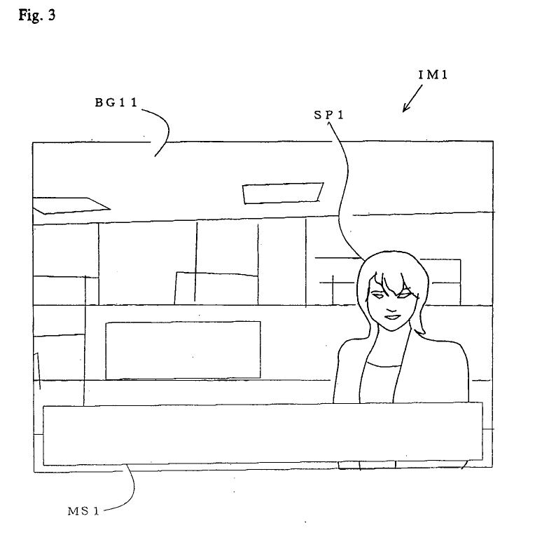

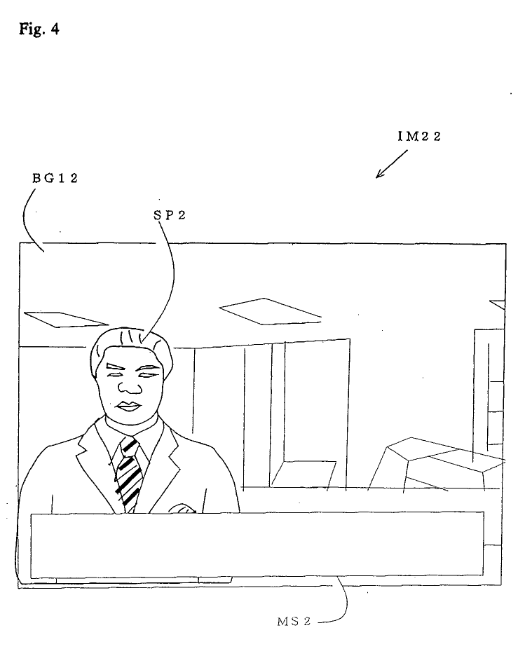

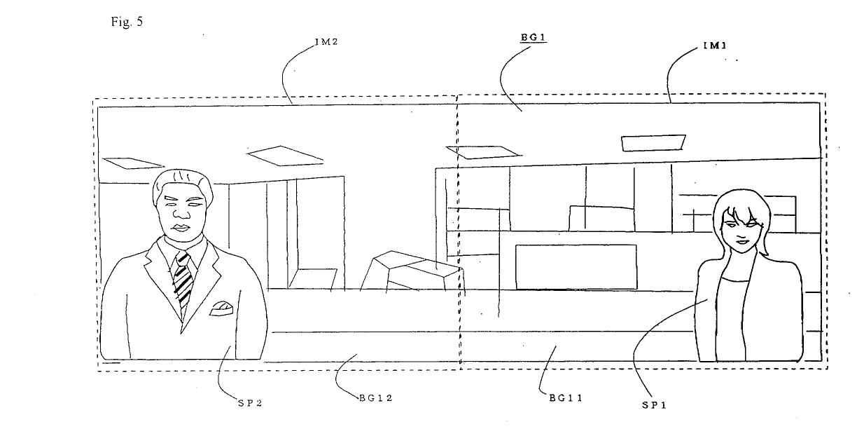

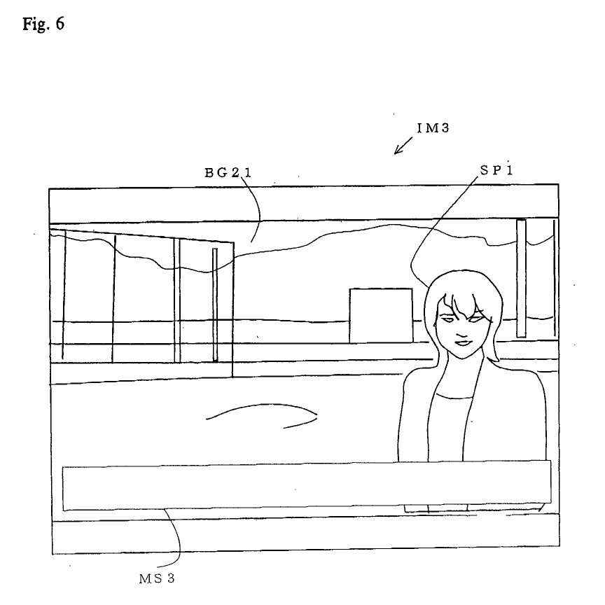

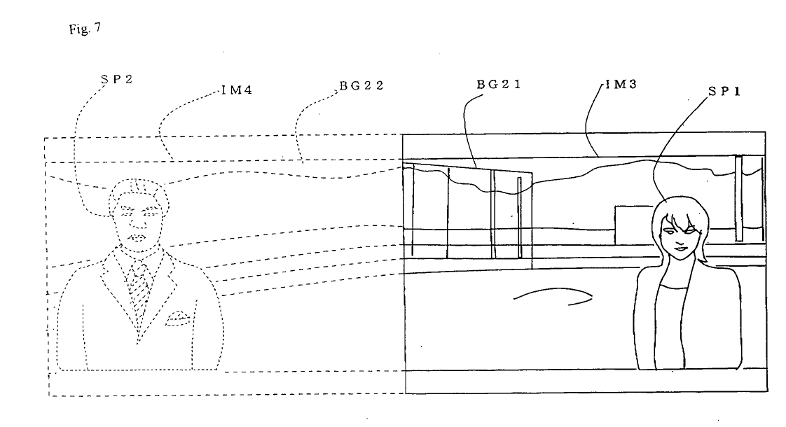

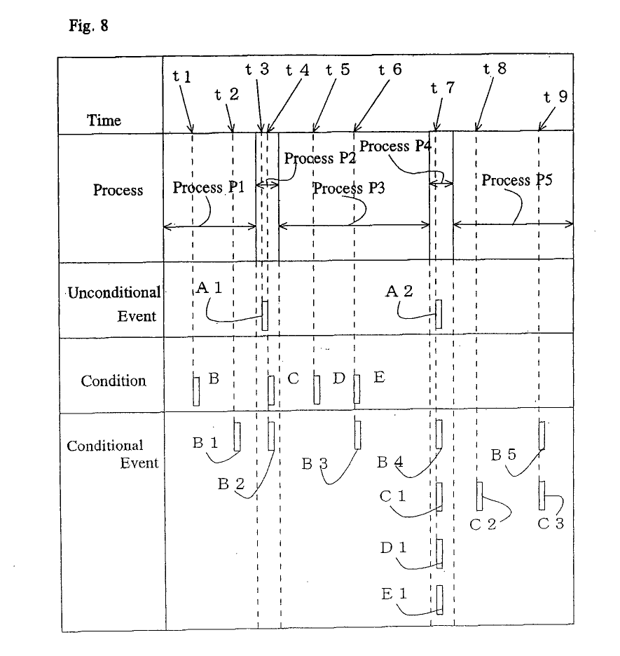

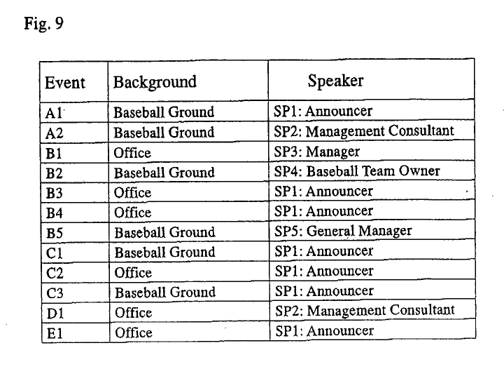

For example, the game is a baseball game having images of events generation as shown in FIGS. 3, 4 and 6. FIG. 5 shows an image including a continuous backgrounds used in the events of FIGS. 3 and 4. FIG. 7 is an image showing a series of backgrounds used in the events of FIG. 6 and others. FIG. 8 is a diagram showing an example of events generation timing. FIG. 9 is a table showing backgrounds and speakers in respective events in FIG. 8.

FIG. 3 shows an image IM1 including a background BG11 of an office and a speaker SP1 of a female announcer. A message MS1 spoken by the speaker SP1 is also shown in the image IM1.

FIG. 4 shows an image IM2 including another background BG12 of the office and a speaker SP2 of a male announcer. A message MS2 spoken by the speaker SP2 is also shown in the image IM2.

FIG. 6 shows an image IM3 including a background BG21 of a playground and a speaker SP1, and a message MS3 spoken by the speaker SP1 is also shown.

Each of the events is executed by an event information including the first data “background (background image data)” and the second data “speaker” with sentence data showing contents of the event. The first background data is an external feature and the second speaker data is an internal feature as an detailed information of the event content.

However, the first data may be other image data than the background data. The second data may be any explanatory or explanation data explaining events such as text data.

Here, “event data information” is for example an information of game progress status generated according to various parameters during progress of a game. The event data information is by displayed on a display means so as to be shown to users, so that the users judges game status at present and in future.

Since the first data is of a rather large data size, it takes considerably long time for reading the data from the memory medium and for writing the data into the memory 1020. The first data is combined with the second data for an event. In the memory medium, the first data group including a plurality of the first data and the second data group including a plurality of the second data are stored.

The present embodiment decreases a loading (reading) time of the information when the events of FIGS. 3 and 4 are to be executed at a simultaneous timing.

Since backgrounds BG11 and BG12 of FIGS. 3 and 4 are commonly an office, a background BG1 of FIG. 5 of a continuous office image can be applied to both the events of FIGS. 3 and 4. The background BG1 consists of right-half portion of the background BG11 and a left-half portion of the background BG12. By loading just one image BG1, both the backgrounds BG11 and Bg12 can be displayed. The event information can be constructed and output by loading (reading) the speakers' images SP1 and SP2 and messages MS1 and MS2, and by combining the background images BG11 and BG12 with them.

As for the information loading, the CPU 1050, system memory 1020 and CD-ROM drive 1090 function cooperatively as a loading (reading) means.

As for the event data information construction by the combination of the first and second data, the CPU 1050, system memory 1020 and CD-ROM drive 1090 function cooperatively as an event data construction means.

When the background BG1 is panned by rotating the visual line horizontally from right to left and vice verse so that the background BG11 (FIG. 3) and BG12 (FIG. 4) are switched.

Therefore, the loading time of the event data information is decreased and it is possible to switch events by natural and smooth change of images.

When the event of FIG. 6 is to be executed in addition to the events of FIGS. 3 and 4 at a simultaneous timing. Events of FIGS. 3 and 4 using the office backgrounds and the event of FIG. 6 using the playground background are classified. The events of the same group are continuously executed separately from other groups so that the total loading time of the information is decreased. For the events classification, the events are sorted with respect to the backgrounds, first.

In one event group of the similar backgrounds or of the same kind of background, the event data information are sorted with respect to the speakers so that the events of the same speakers are continuously generated. Therefore, the panning (image switching) time is minimized.

As for the first sorting of the event data information by the data “background”, the CPU 1050, system memory 1020 and CD-ROM drive 1090 function cooperatively as a first sorting means.

As for the second sorting of the event data information by the data “speaker” after the first sorting, the CPU 1050, system memory 1020 and CD-ROM drive 1090 function cooperatively as a second sorting means.

As shown in FIG. 7, other backgrounds such as the “playground” may be a continuous background BG2 consisting of the background BG21 and BG22. By switching (panning) the backgrounds BG21 and BG22 from one to the other so that the events of the speaker SP1 and the other (for example SP2) can be switched.

As for the event switching, the CPU 1050 and system memory 1020 function cooperatively as a switching means.

As for the event execution, the CPU 1050, system memory 1020, graphic memory 1040, graphic processor 1030, audio memory 1080 and audio processor function cooperatively as an event execution means. In FIG. 8, during progression of the baseball game etc., processing P1, P2, P3, P4 and P5 are executed successively. During execution of the processing P2 and P4, unconditional events A1 and A2 are generated at timing t3 and t7, respectively. The unconditional events are executed without fail, regardless of any conditions. For example, the events A1 and A2 are “trade of baseball players” and “substitution of manager”, respectively.

As the game advances, conditions B, C, D and E occur during execution of the processing P1, P2, P3 and P4 at timing t1, t3, t5 and t6, respectively. For example, the conditions B, C, D and E are “A player exercises extremely hard training”, “The manager ordered to leave the ground”, “A pitcher completes a perfect game” and “The total number of homers of a player exceeds the world record”, respectively.

By the occurrence of the condition B, conditional events B1, B2, B3, B4 and B5 occur during the execution of the processing P1, P2, P3, P4 and P5 at timing t2, t4, t6, t7 and t9, respectively.

By the occurrence of the condition C, conditional events C1, C2 and C3 occur during the execution of the processing P4 at timing t7, t8 and t9, respectively.

By the occurrence of the condition D, a conditional event D1 occurs during the execution of the processing P4 at a timing t7.

By the occurrence of the condition E, a conditional event E1 occurs during the execution of the processing P4 at a timing t7.

And a plurality of events B4, C1 and D1 occur at a timing t7, and a plurality of events B5 and C3 occur at a timing t9.

The conditional events occur due to occurrence of predetermined conditions, that is, the events B1 to B5 are caused by the condition B.

For example, the event B1 is a good performance due to the hard training B, the event B2 is an injury after the good performance, the event B3 is a demotion to a miner class, the event B4 is a promotional return to a major class and the event B5 is marvelous performances after the return.

For example, the event C1 is a good team works due to the absence of the manager, the event C2 is a return of the manager and the event C3 is a good result of the team.

For example, the event D1 is a “no-no” pitching etc. of another pitcher triggered by the perfect game.

For example, the event E1 is a National Honor Prize to a player.

As for setting the timing of the event execution, the CPU 1050 and system memory 1020 function cooperatively as a timing setting means.

As for judgment whether a plurality of events are to be executed at a simultaneous timing, the CPU 1050 and system memory 1020 function cooperatively as a plural events judgment means.

In FIG. 9, for example, events A1, A2, B1, B2, B3, B4, B5, C1, C2, C3, D1 and E1 have backgrounds of “playground”, “playground”, “office”, “playground”, “office”, “playground”, “playground”, “playground”, “playground”, “office” and “office”, and speakers of “SP1”, “SP2”, “manager (SP3)”, “owner (SP4)”, “SP1”, “SP1”, “general manager (SP5)”, “SP1”, “SP1”, “SP1”, “SP2” and “SP1”, respectively.

[Game Control Program]

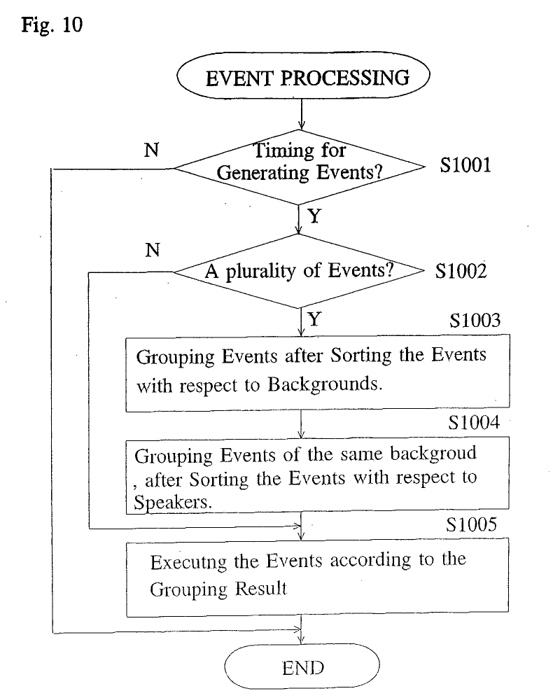

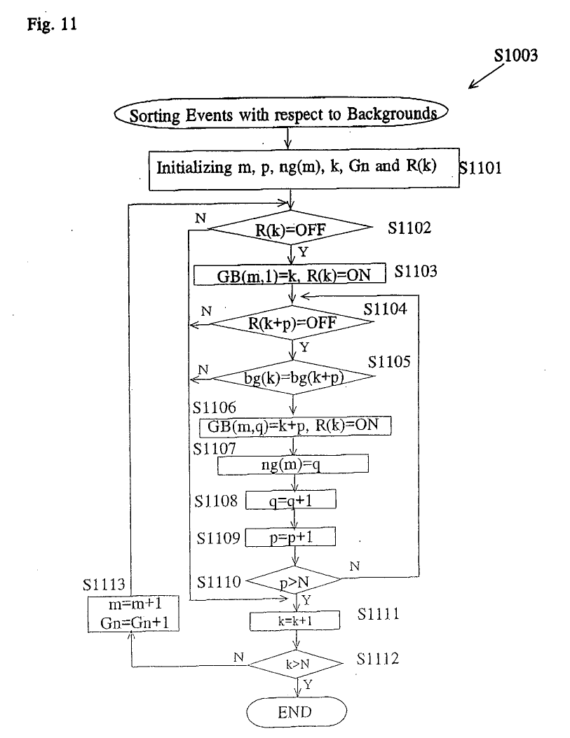

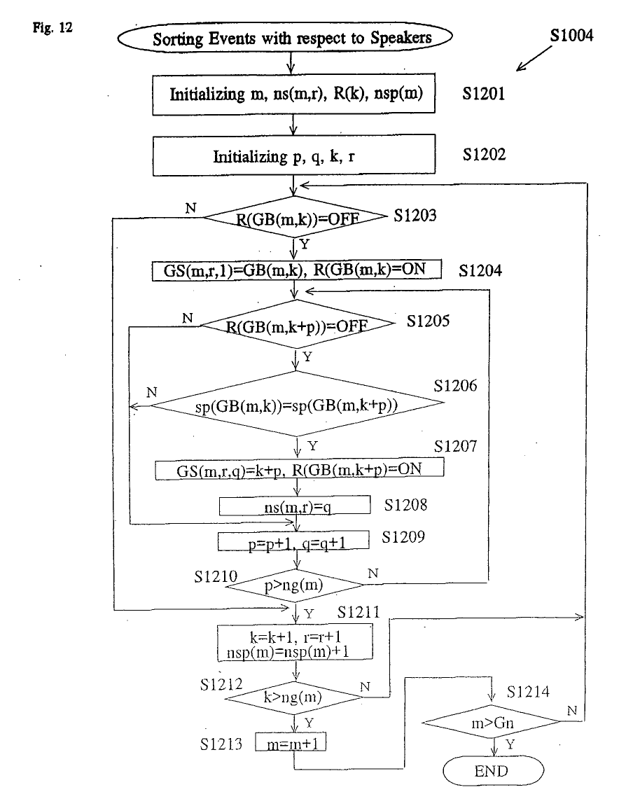

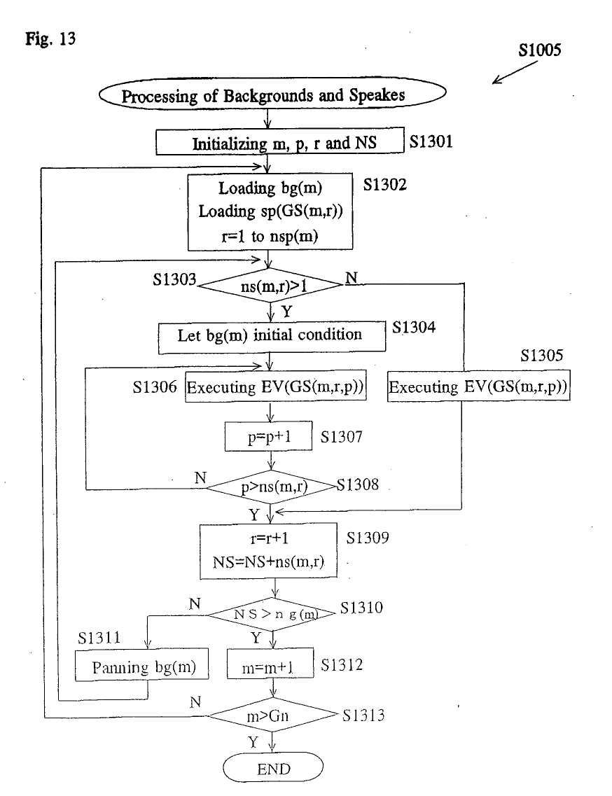

FIG. 10 is a flowchart showing a processing for generating events of the game information processing apparatus. FIG. 11 is a flowchart showing a processing for sorting with respect to plurality of backgrounds. FIG. 12 is a flowchart showing a processing of sorting with respect to a plurality of speakers. FIG. 13 is a flowchart showing a processing for generating a plurality of events.

In FIG. 10, the processing for generating events are performed by the following steps.

Step S1001: It is judged whether it is a timing to generate events, as the timing t2, t3, t4, t6, t7, t8 and t9. If it is a timing to generate a event, the processing is advanced to the step S11002, otherwise the processing is terminated directly.

Step S1002: It is judged whether there are a plurality of events to be generated or not. If a plurality events are to be generated, the processing is advanced to the step S1003, otherwise the processing is advanced to the step S1005.

Step S1003: The event data information are sorted with respect to the backgrounds so as to be classified and the processing is advanced to the step S1004.

Step S1004: The event data information having the background of the same are sorted with respect to the speakers so as to be classified and the processing is advanced to the step S1005.

Step S1005: The events are executed according to the classification result and the processing is terminated.

For example, a plurality of events B4, C1, D1 and E1 occur at the timing t7 and the events B4, D1 and E1 have common kind of background of “office”. The event C1 has a background “playground”.

Therefore, the events are classified into a group of the events B4, D1 and E1 and a group of event C1.

Then, the events B4 and E1 have the common speaker “announcer”, the event D1 has the different speaker “management consultant” from that of the events B4 and E1.

Therefore, the events 4, E1 and D1 are classified into a group of the events B4 and E1 and a group of event D1 by the Step S1004.

When the events are executed by the Step S1005, the events are successively and continuously executed in the group of the events B4 and E1. After or before the execution of the group of B4 and E1, the event D1 is executed.

The time for information loading and image switching is decreased.

In FIG. 11, the sorting processing of the event data information with respect to the event backgrounds (Step S1003 in FIG. 10) is executed by the following steps.

Here, variables are defined as follows.

k: serial number of each event,

N: total number of the events,

EV(k): kth event,

bg(k): background of kth event EV(k),

sp(k): speaker of kth event EV(k),

GB(m): group of the background of the same kind,

GB(m,q): serial number k of qth member of the group GB(m),

ng(m): total number of events in the group GB(m), and

Gn: total number of groups.

Step S1101: First, the variables m, n, ng(m) and ng(m,n) are initialized, and counters k and p and a flag R(k) used in the following steps are initialized. The flag R(k) indicates whether a event EV(k) has already been sorted with respect to the background or not. R(k) is “ON” when already sorted and “OFF” when not sorted.

Step S1102: Following to the Step 1101, it is judged whether the flag R(k) of the event EV(k) is OFF or not, that is, whether the event has been already processed or not.

Step S1103: The first member of the group GB(m) is substituted by EV(k), and the serial event number GB(m,1) of the group GB(m) is substituted by k. R(k)=ON because EV(k) has already been an object of the sorting processing.

Step S1104: Following to the Step 1103, it is judged whether the EV(k+p) has been already processed or not. The background of EV(k+p) is to be compared with that of the member GB(m,1). If R(k+p)=OFF, the processing is advanced to the step S1105. If R(k+p)=ON, the processing is advanced to the step S1110.

Step S1105: It is judged whether the background bg(k) of the event EV(k) coincides with the background bg(k+p) of the EV(k+p) or not. If bg(k)=bg(k+p), the processing is advanced to the step S1106, otherwise, the processing is jumped to the step S1111.

Step S1106: As a new serial number GB(k+p) of the group GB(m), (k+p) is appended, and the flag R(k+p) of the event EV(k+p) is changed to ON (already processed).

Step S1107: The total events number ng(m) of the group G(m) is increased to be “q”, and the processing is advanced to the Step S1108.

Step S1108: The counter “q” is increased by “1”, and the processing is advanced to the Step S1109.

Step S1109: The counter “p” is increased by “1”, and the processing is advanced to the Step S1110.

Step S1110: It is judged whether the backgrounds of all other events than the event EV(k) are compared with the background bg(k) of the event EV(k) or not. If the total comparison is completed, the processing is advanced to the step S1111, otherwise, the processing is returned to the step S1104.

Step S1111: The counter “k” is increased by “1”, and the processing is advanced to the Step S1112.

Step S1112: It is judged whether the total events EV(k) (k=1 to N) are evaluated or not. If the total events are evaluated, the processing is terminated directly, otherwise, the processing is returned to the step S1113.

Step S1113: The counter “m” and the total number of the groups Gn are increased by “1”, and the processing is returned to the Step S1102 for searching events in the next group.

By the processing in FIG. 11, events of the same kind are gathered in one group.

In FIG. 12, the sorting processing of the event data information with respect to the event speakers (Step S1004 in FIG. 10) is executed by the following steps.

Here, variables are defined as follows.

m: serial number of each group,

k: serial number of each event in the group GB(m),

r: serial number of each speaker in the group GB(m),

ns(m,r): total number of events of the rth speaker in the group GB(m),

GS(m,n): group of the same speaker in each group of the same kind of background,

GS(m,r,q): qth event of rth speaker in the mth group GB(m), and

nsp(m): total number of speakers of the group GB(m).

Step S1201: First, the variables m, n and ns(m,r) are initialized, and the processing is advanced to the Step S1202.

Step S1202: The counters p, q and k and the flag R(k) are initialized. The flag R(k) indicates whether the kth event has been sorted with respect to the speakers. R(k) is “ON” if the event has already been the object of the sorting processing, otherwise, R(k)=OFF.

Step S1203: Following to the Step S1201, it is judged whether the flag R(k) of the event EV(k) is OFF (not processed) or not. If the event has been processed (R(k)=ON), the processing is jumped to the Step S1211, otherwise, the processing is advanced to the Step S1204.

Step S1204: The kth event GB(m,k) is substituted by the first event GS(m.r.1) of the rth speaker in the mth group GB(m). Then, R(GS(m,k))=ON because GS(m,k) has already been an object of the processing.

Step S1205: Following to the Step 1204, it is judged whether the event member GB(m,k+p) has been already compared, with respect to the speaker, to the event GS(m,r,1) in the group GB(m). If R(GB(m,k+p))=ON, the processing is jumped to the step S1209.

Step S1206: It is judged whether the speaker sp(GB(m,k)) of the event GS(GB(m,k)) coincides with the speaker sp(GB(m, k+p)) of the GS(GB(m,k+p)) or not. If sp(GB(m,k))=sp(GB(m,k+p)), the processing is advanced to the step S1207, otherwise, the processing is jumped to the step S1209.

Step S1207: As a new serial number GS(m,r,q) of the group GS(m,r), (k+p) is appended, and the flag R(GB(m,k+p)) of the event GB(m,k+p) is changed to ON (already processed).

Step S1208: The total events number ns(m,r) of the group GS(m,r) is increased to be “q”, and the processing is advanced to the Step S1209.

Step S1209: The counter “p” and “q” are increased by “l”, and the processing is advanced to the Step S1210.

Step S1210: It is judged whether the comparison of the events GB(m,k) with respect to the speakers is completed or not in the group GB(m). If the comparison is completed, the processing is advanced to the step S1211, otherwise, the processing is returned to the step S1205.

Step S1211: The counter “k” and “r” and the total number nsp(m) of the speakers are increased by “1”.

Step S1212: It is judged whether the total comparison of the speakers is completed in the group GB(m) or not. If the total comparison is completed, the processing is advanced to the step S1213, otherwise, the processing is returned to the step S1203.

Step S1213: The serial number “m” of the group is increased by “1”, and the processing is advanced to the Step S1214.

Step S1214: It is judged whether the processing of the total groups is completed. If the processing is completed, the processing is terminated directly, otherwise, the processing is returned to the step S1202.

By the processing in FIG. 12, events of the same speaker are gathered in one group.

In FIG. 13, the events sorted y the processing of FIGS. 11 and 12 are executed by the following steps.

Here, variables are defined as follows.

m: serial number of each group,

r: serial number of each speaker in the group GB(m),

p: serial number of each event of the rth speaker, and

NS: total number of events already processed in one group.

Step S1301: First, the variables m, p, r and NS are initialized, and the processing is advanced to the Step S1302.

Step S1302: The background bg(m) and the total speakers sp(GS(m,r)) (r=1 to nsp(m)) in the group GB(m) are loaded, and the processing is advanced to the Step S1303.

Step S1303: It is judged whether the total number ns(m,r) of events is more than “1” or not. If the total number is more than “1”, the processing is advanced to the Step S1304, otherwise, the processing is advanced to the step S1305.

Step S1304: The background bg(m) is set to be an initial condition and displayed. The initial condition is for example the right-half image BG11

Step S1311: The background bg(m) is panned (switched), and the processing is advanced to the Step S13003.

Step S1312: The counter “m” is increased by “1”, and the processing is advanced to the Step S1313.

Step S1313: It is judged whether the processing of the total background groups or not. If the total processing is completed, the processing is terminated directly, otherwise, the processing is returned to the step S1302.

By the processing in FIG. 13, the information loading time and the image switching time are minimized so that users feel little stress.

In the above embodiment, events including the background and speaker of the baseball game are described. However, the present invention is applicable to events including other objects than the background and speaker. The background may be either a still image or a moving image.

In the above embodiment, the background data of rather large volume is sorted first, then the speaker data of rather small volume is sorted. However, the data volume may be classified into more grades than two so that event execution in a order according to a sorting result of the more grades is executed.

with respect to the background BG1. Then, the processing s advanced to the Step S1305.

Step S1305: The event EV(GS(m,r,p)) is executed, and the processing is advanced to the Step S1310.

Step S1306: The event EV(GS(m,r,p)) is executed, and the processing is advanced to the Step S1306.

Step S1307: The counter “p” is increased by “1”, and the processing is advanced to the Step S1308.

Step S1308: It is judged whether the total execution of the events of the same speaker is completed or not. If the total execution is completed, the processing is advanced to the step S1310, otherwise, the processing is advanced to the step S1309.

Step S1309: The counter “r” and the total number of events NS are increased by “1”, and the processing is advanced to the Step S1310.

Step S1310: It is judged whether the total execution of the events in the group of the same kind background or not. If the total execution is completed, the processing is advanced to the step S1312, otherwise, the processing is advanced to the step S1311.

The information to be loaded is not limited to the image data. Sound data and other data may be loaded.

Advantages of the present invention include that the user's stress is minimized when loading the information.

What is claimed is:

1. A game information processing apparatus comprising,
a display means for displaying an event on a display monitor, said events being generated when a predetermined condition is fulfilled,
a memory means for storing events data information for executing said event generated, said events data information comprising first and second data groups,
a reading means for selectively reading data corresponding to said event from both said first and second data groups,
an event data constructing means for constructing said read data of said first and second groups so as to construct said event data information,
a timing determining means for determining a execution timing of said event data information read by said reading means,
a plural events judging means for judging, when a plurality of events are generated, whether said events are to be executed at a simultaneous timing or not,
a first sorting means for sorting said plurality of events to be executed at said simultaneous timing with respect to said first data,
a second sorting means for further sorting said plurality of events sorted by said first sorting means, with respect to said second data,
a switching means for switching said event data information in a order corresponding a sorting result of said events sorted by said first and second sorting
an event execution means for executing said event data information switched by said switching means.

2. A game information processing apparatus according to claim 1, wherein said data of said first data group includes an image data and said data of said second data group includes an explanation text data explaining said event.

3. A game information processing apparatus according to claim 2, wherein said image data of said first data group includes a background image data.

4. A game information processing apparatus according to claim 2, wherein said data of said second data group includes image of speakers.

5. A game information processing apparatus according to claim 2, wherein said switching means pans one image when said image is commonly used for said events executed at said simultaneous timing.

6. A game control program including program codes executable by a computer comprising,
a display step for displaying an event on a display monitor, said events being generated when a predetermined condition is fulfilled,
a reading step for selectively reading data corresponding to said event, from a memory means, events data information for executing said event generated, said events data information comprising first and second data groups,
an event data constructing step for constructing said read data of said first and second groups so as to construct said event data information,
a timing determining means for determining a execution timing of said event data information read by said reading step,
a plural events judging step for judging, when a plurality of events are generated, whether said events are to be executed at a simultaneous timing or not,
a first sorting step for sorting said plurality of events to be executed at said simultaneous timing with respect to said first data,
a second sorting step for further sorting said plurality of events sorted by said first sorting means, with respect to said second data,
a switching step for switching said event data information in a order corresponding a sorting result of said events sorted by said first and second sorting means, and
an event execution step for executing said event data information switched by said switching means.

7. A game control program according to claim 6, wherein said data of said first data group is an image data and said data of said second data group includes an explanation text data explaining said event.

8. A game control program according to claim 7, wherein said image data of said first data group includes a background image data.

9. A game control program according to claim 7, wherein said data of said second data group includes image of speakers.

10. A game control program according to claim 7, wherein said switching step pans one image when said image is commonly used for said events executed at said simultaneous timing.

11. A memory medium readable by a computer, which stores said game control program according to claim 6.
